(19) United States
(12) Patent Application Publication
(10) Pub. No.: US 2005/0093418 A1
(43) Pub. Date: May 5, 2005

(54) Light source

(76) Inventors: Albrecht Kraus, Kerkrade (NL); Peter Klaus Bachmann, Wurselen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/506,405

(22) PCT Filed: Feb. 26, 2003
(86) PCT No.: PCT/IB03/00733

(30) Foreign Application Priority Data
Mar. 7, 2002 (DE) 102100454

(51) Int. Cl. H01J 1/46; H01J 21/10

(52) U.S. Cl. 313/293

(57) ABSTRACT

The invention relates to a light source (1) with a discharge vessel (2) which is filled with a filling gas, and with an electron beam source (4) arranged in vacuum or in a region of low pressure, which source (4) generates electrons (12) and propels them through an inlet foil (8) into the discharge vessel (2). According to the invention, the inlet foil (8) comprises a diamond layer.

The invention relates to a light source with a discharge vessel which is filled with a filling gas, and with an electron beam source arranged in vacuum or in a region of low pressure, which source generates electrons and propels them through an inlet foil into the discharge vessel.

The electron beam source, also denoted electron gun hereinafter, is operated in high vacuum so as to avoid destruction of the cathode by ionized residual gases. An ultra-thin inlet foil is tensioned between the vacuum, in which the electron gun is present, and the gas space of the discharge vessel, in which an approximately atmospheric pressure prevails, through which foil the electron beam is not subjected to any substantial energy loss. Such a light source, which comprises a discharge vessel with a filling gas into which electrons are propelled from the electron gun through the thin inlet foil, is known from U.S. Pat. No. 6,052,401. The inlet foil, also denoted inlet membrane hereinafter, is an approximately 300 nm thick silicon nitride membrane which is resistant to pressure differences of a few bar, given a width of a little less than 1 mm and any length as desired. The silicon nitride membranes used until now, however, constitute a factor limiting the life, size, shape, and gas filling of the respective light source because of their limited strength, their low corrosion resistance, their small thermal conductivity, and their limited operational stability under electron bombardment, as well as their low sputter resistance. Given a width of approximately 1 mm, such foils will burst at a differential pressure of approximately 2 bar, and it is only a reduction of the foil width to 0.7 mm, which is undesirable, which renders possible pressures of 3 to 4 bar. Higher operational pressures of 4 to 8 bar, however, are desired in particular for operation with light rare gases. Substantially larger pressure-resistant foils are also necessary for enlarging the discharge zone. A strong foil corrosion resulting from the use of gas fillings comprising fluorine are the cause that no such light sources have yet been realized. Since a not inconsiderable heat generation takes place in the gas space in the foil region, the beam currents used until now are limited, because the foil material is insufficiently capable of removing this heat. The low sputter resistance of the silicon nitride membrane strongly limits the service life and the beam current of the lamp.

The invention accordingly has for its object to provide an improved light source. In particular, the foils and the inlet conditions into the discharge vessel are to be improved.

This object is achieved by the characteristics defined in claim 1. According to the invention, the inlet foil comprises a diamond layer. The present invention proposes to construct a light source as above with the use of a thin diamond membrane so as to avoid the disadvantages of the prior art. Diamond foils with dimensions of 5 mm×1.5 mm and a thickness of 2 micrometers are capable of withstanding pressure differences of more than 8 bar. A rule of thumb for round foils is that the pressure resistance ΔP in bar is given by the thickness d of the window foil in micrometers divided by the diameter D in cm, i.e.
ΔP[bar]=d[μm]/D[cm]

A bursting pressure of 1 bar accordingly results for a 1 μm thick diamond foil with a diameter of 1 cm. It is thus possible with diamond foils to irradiate large volumes and to construct correspondingly high-power light sources. The thermal conductivity of diamond at room temperature is higher than that of any other material. The thermal load on the foils is reduced thereby. Diamond is also resistant to gas mixtures comprising fluorine and renders possible, for example, ArF or KrF discharges.

Advantageously, the electron beam source comprises a thermionic electron emitter. This is a hot electron emitter in which, for example, a tungsten wire is used.

Advantageously, the electron beam source comprises a field emitter. The field emitter may be constructed, for example, on the basis of carbon nanotubes. Field emitters, for example carbon nanotubes, may be brought into emission over wide surface areas, so that large windows can be homogeneously irradiated with electron sources of this kind, or alternatively elongate slot geometries can be illuminated.

An embodiment of the invention will be explained in more detail below for better understanding with reference to the drawing, in which

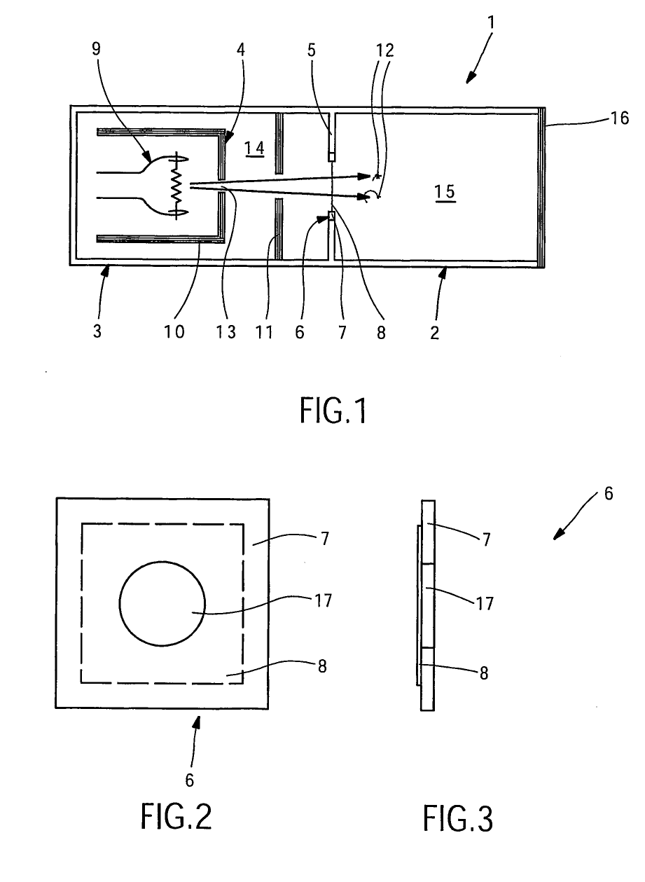

FIG. 1 shows a light source with an inlet foil in cross-section,

FIG. 2 shows a diamond window in plan view, and

FIG. 3 shows the diamond window in side elevation.

FIG. 1 shows a light source 1, also denoted gas discharge lamp hereinafter, with a discharge vessel 2 and a high-vacuum chamber 3 in which an electron beam source 4 is arranged. The discharge vessel 2 and the high-vacuum chamber 3 are separated by an interior wall 5. The wall 5 has an inlet window 6 with a frame 7 and a foil 8. The electron beam source 4 has a heated cathode 9, a Wehnelt cylinder 10, and a ring anode 11. Electrons 12 are emitted from the heated cathode 9 and pass through an opening 13 of the Wehnelt cylinder 10 into an acceleration region 14. Here the electrons 12 are accelerated towards the ring anode 11, which they pass with an energy of approximately 10 keV. Subsequently they pass through an approximately 1 micrometer thin inlet foil 8 of diamond into a gas space 15 of the discharge vessel 2. When passing through the diamond foil 8, the electrons 12 lose no more than 10% of their energy, depositing the remainder in the gas space 15 in a locally strongly limited manner, said gas space being filled with 100 mbar xenon. The generated continuous UV radiation around 170 nm is converted into visible light by a phosphor provided on the inner side of the discharge vessel 2. The negative charge introduced from the outside into the gas space 15 must be drained off to an external current circuit again via a conductive plate 16.

FIGS. 2 and 3 show the inlet window 6 with the frame 7 and the diamond foil 8. The frame 7 is a carrier 7 whose central portion was etched away such that a round opening 17 was formed, which is also denoted window opening hereinafter. The foil 8 is arranged on the carrier 7. Diamond foils as used for the construction of such a light source 1 can be obtained by deposition from a gas phase. During this, carbon atoms are deposited on the carrier 7, denoted substrate hereinafter, and build up a diamond layer which forms the foil 8. To manufacture a diamond window 6, carbon atoms are deposited on silicon, whereupon the window opening 17 is exposed by etching. The remaining silicon forms the window frame 7. Alternatively, diamond foils 8 may be fully removed from their original substrate 7 used in the deposition process and may subsequently be glued to a new window frame 7 made from any material as desired, such as a metal, a synthetic resin, or glass, or may be connected thereto by brazing techniques with active AgCuTi brazing agents. Further possible window frame materials are thicker diamond layers, quartz glass, and further materials with a very low coefficient of thermal expansion.

### LIST OF REFERENCE NUMERALS

1 light source
2 discharge vessel
3 high-vacuum chamber
4 electron beam source
5 wall
6 inlet window
7 frame
8 foil
9 cathode
10 Wehnelt cylinder
11 ring anode
12 electrons
13 opening
14 acceleration region
15 gas space
16 plate
17 opening

1. A light source (1) with a discharge vessel (2) which is filled with a filling gas, and with an electron beam source (4) arranged in vacuum or in a region of low pressure, which source (4) generates electrons (12) and propels them through an inlet foil (8) into the discharge vessel (2), characterized in that the inlet foil (8) comprises a diamond layer.

2. A light source as claimed in claim 1, characterized in that the diamond layer has a thickness below 100 μm, in particular below 50 μm, advantageously below 20 μm.

3. A light source as claimed in claim 1, characterized in that the diamond layer has a frame (7).

4. A light source as claimed in claim 1, characterized in that the diamond layer has a metal brazing layer.

5. A light source as claimed in claim 1, characterized in that the diamond layer has an organic adhesion layer.

6. A light source as claimed in claim 1, characterized in that the electron beam source comprises a thermionic electron emitter.

7. A light source as claimed in claim 1, characterized in that the electron beam source comprises a field emitter.

8. A method of manufacturing a foil (8) for a light source (1), characterized by the following process steps:
carbon atoms are deposited on a substrate (7) so as to form a diamond foil (8), and
a portion of the substrate is etched away such that a remaining portion (7) of the substrate forms a frame (7) for the diamond foil (8).

9. A method of manufacturing a foil (8) for a light source (1), characterized by the following process steps:
carbon atoms are deposited on a substrate so as to form a diamond foil (8),
the diamond foil (8) is removed from the substrate, and
the diamond foil (8) is brazed to a frame (7).

10. A method of manufacturing a foil (8) for a light source (1), characterized by the following process steps:
carbon atoms are deposited on a substrate so as to form a diamond foil (8),
the diamond foil (8) is removed from the substrate (7), and the diamond foil (8) is adhered to a frame (7).
